(19) United States
(12) Patent Application Publication
(10) Pub. No.: US 2022/0089890 A1
(43) Pub. Date: Mar. 24, 2022

(54) Dispersion Liquid, Ink Composition For Ink Jet Recording, And Dispersion Resin

(71) Applicant: Seiko Epson Corporation, Tokyo (JP)

(72) Inventors: Mami TOJINO, Shiojiri (JP); Toshihiro OTAKE, Chino (JP); Koichi TERAO, Suwa (JP); Hiroshi ITO, Matsumoto (JP); Koji HORIBA, Matsumoto (JP)

(21) Appl. No.: 17/482,495

(22) Filed: Sep. 23, 2021

(30) Foreign Application Priority Data
Sep. 24, 2020 (JP) 2020-159271

(51) Int. Cl. C09D 11/328; C09D 11/107; C09D 11/033

(52) U.S. Cl. CPC C09D 11/328; C09D 11/033; C09D 11/107

(57) ABSTRACT

A dispersion liquid includes water, a coloring material, and a dispersion resin that disperses the coloring material. The dispersion resin has a constituent unit A containing a hydrophobic monomer, a constituent unit B containing a hydrophilic acrylic acid monomer, and a constituent unit C containing a hydrophilic vinyl monomer having a sulfonate group, and the weight-average molecular weight of the dispersion resin is 10,000 to 100,000. The content of the constituent unit A is 60 mol % or more relative to the total amount of the dispersion resin.

The present application is based on, and claims priority from JP Application Serial Number 2020-159271, filed Sep. 24, 2020, the disclosure of which is hereby incorporated by reference herein in its entirety.

### BACKGROUND

### 1. Technical Field

The present disclosure relates to a dispersion liquid, an ink composition for ink jet recording, and a dispersion resin.

### 2. Related Art

An ink jet recording method is capable of recording high-definition images by a relatively simple apparatus, and rapid development is achieved in various fields. In particular, various investigations are carried out to obtain images with high quality while suppressing mist contamination of a recording head. For example, JP-A-2017-002096 discloses an ink for pigment ink jet recording, which contains pigment particles dispersed in a styrene-acrylic resin.

However, an ink composition containing a usual dispersant such as the styrene-acrylic resin described in JP-A-2017-002096 has a problem that when a coloring material is solidified due to drying of an ink, the ink composition is subsequently hardly re-dispersed, thereby easily causing failure during re-ejection after drying.

### SUMMARY

According to an aspect of the present disclosure, a dispersion liquid includes water, a coloring material, and a dispersion resin which disperses the coloring material, the dispersion resin having a constituent unit A containing a hydrophobic monomer, a constituent unit B containing a hydrophilic acrylic acid monomer, and a constituent unit C containing a hydrophilic vinyl monomer having a sulfonate group. The weight-average molecular weight of the dispersion resin is 10,000 to 100,000, and the content of the constituent unit A being 60 mol % or more relative to the total amount of the dispersion resin.

According to an aspect of the present disclosure, an ink composition for ink jet recording includes the dispersion liquid described above, a surfactant, and a water-soluble organic solvent.

According to an aspect of the present disclosure, a dispersion resin has a constituent unit A containing a hydrophobic monomer, a constituent unit B containing a hydrophilic acrylic acid monomer, and a constituent unit C containing a hydrophilic vinyl monomer having a sulfonate group. The weight-average molecular weight of the dispersion resin is 10,000 to 100,000, and the content of the constituent unit A is 60 mol % or more relative to the total amount of the dispersion resin.

### DESCRIPTION OF EXEMPLARY EMBODIMENTS

An embodiment of the present disclosure (referred t to as a “present embodiment” hereinafter) is described in detail below, but the present disclosure is not limited to this, and various modifications can be made within a scope not deviating from the gist of the present disclosure.

### 1. Dispersion Liquid

A dispersion liquid according to the present embodiment includes water, a coloring material, and a dispersion resin which disperses the coloring material, the dispersion resin having a constituent unit A containing a hydrophobic monomer, a constituent unit B containing a hydrophilic acrylic acid monomer, and a constituent unit C containing a hydrophilic vinyl monomer having a sulfonate group. The weight-average molecular weight of the dispersion resin is 10,000 to 100,000, and the content of the constituent unit A is 60 mol % or more relative to the total amount of the dispersion resin.

A dispersion liquid or ink composition containing a usual dispersion resin has the problem of being hardly re-dispersed once a coloring material is solidified. On the other hand, in the present embodiment, the solidified coloring material can be easily re-dispersed by using the dispersion resin having the configuration described above. Also, even when the ink in a nozzle is dried, re-ejectability (also referred to as “dry ejection characteristics” hereinafter) can be more improved. Each of the components is described in detail below.

### 1.1. Dispersion Resin

The dispersion resin according to the present embodiment is a copolymer having the constituent unit A containing a hydrophobic monomer, the constituent unit B containing a hydrophilic acrylic acid monomer, and the constituent unit C containing a hydrophilic vinyl monomer having a sulfonate group. In the present embodiment, the “monomer” represents a monomer having a polymerizable unsaturated bond before polymerization, and the “constituent unit” represents a repeating unit constituting a portion of the dispersion resin after polymerization. In the present embodiment, the term “hydrophobic” represents the property of being incompatible with water at 25° C., and the term “hydrophilic” represents the property of being compatible with water at 25° C.

The dispersion resin may be either a random copolymer or a block copolymer. Examples of the block copolymer include a triblock copolymer having a block A composed of the constituent unit A, a block B composed of the constituent unit B, and a block C composed of the constituent unit C; a diblock copolymer having a block A composed of the constituent unit A and a random block B/C composed of the constituent unit B and the constituent unit C; and the like. The use of such a dispersion resin tends to more improve re-dispersibility after solidification and more improve the dry ejection characteristics.

The content of the dispersion resin relative to the total amount of the dispersion liquid is preferably 2.5% to 12.5% by mass, more preferably 3.5% to 10% by mass, and still more preferably 4.5% to 9.0% by mass. When the content of the dispersion resin is within the range described above, there is a tendency to more improve re-dispersibility after solidification and more improve the dry ejection characteristics.

The content of the dispersion resin relative to 100 parts by mass of the coloring material is preferably 20 to 100 parts by mass, more preferably 30 to 80 parts by mass, and still more preferably 40 to 70 parts by mass. When the content of the dispersion resin is within the range described above, there is a tendency to more improve re-dispersibility after solidification and more improve the dry ejection characteristics.

### 1.1.1. Constituent Unit A

The constituent unit A is a constituent unit containing a hydrophobic monomer and partially imparts hydrophobicity to the dispersion resin. Although not particularly limited, the constituent unit A is aligned on the surface of the coloring material due to hydrophobic interaction or the like and thus can contribute to adsorption of the dispersion resin to the coloring material.

Examples of the hydrophobic monomer constituting the constituent unit A include, but are not particularly limited to, vinyl monomers having an aromatic group, such as styrene, methylstyrene, other styrene derivatives, and the like; and acrylic acid ester monomers having a hydrocarbon group, such as methyl (meth)acrylate, ethyl (meth)acrylate, butyl (meth)acrylate, isopropyl (meth)acrylate, isobutyl (meth)acrylate, pentyl (meth)acrylate, isoamyl (meth)acrylate, hexyl (meth)acrylate, 2-ethylhexyl (meth)acrylate, benzyl (meth)acrylate, and the like. In the present embodiment, “(meth)acrylate” includes acrylate and methacrylate. The hydrophobic monomers may be used alone or in combination of two or more.

Among these, at least one of the vinyl monomers having an aromatic group, such as styrene and the like; and the acrylic acid ester monomers having a hydrocarbon group, such as benzyl acrylate and the like, is more preferably contained. The use of the hydrophobic monomer tends to more improve the adsorptivity of the dispersion resin to the coloring material, more improve re-dispersibility after solidification, and more improve the dry ejection characteristics.

The content of the constituent unit A relative to the total amount of the dispersion resin is 60 mol % or more, preferably 62 to 90 mol %, and more preferably 62 to 82 mol %. When the content of the constituent unit A is 60 mol % or more, the adsorptivity of the dispersion resin to the coloring material is more improved. Also, when the content of the hydrophobic constituent unit A is 60 mol % or more, the hydrophilicity of the dispersion resin itself is generally decreased, but water solubility of the dispersion resin of the present embodiment can be secured due to the contribution of another constituent unit, particularly the constituent unit C. Therefore, there is a tendency to more improve the adsorptivity of the dispersion resin to the coloring material, more improve re-dispersibility after solidification, and more improve the dry ejection characteristics.

### 1.1.2. Constituent Unit B

The constituent unit B is a constituent unit containing a hydrophilic acrylic acid monomer and partially imparts hydrophilicity to the dispersion resin. Although not particularly limited, the constituent unit B is aligned on the side opposite to the surface of the coloring material and thus can contribute to improvement in the dispersibility. Further, the constituent unit B softens the constituent unit A and the constituent unit C having a large difference in polarity, and thus having the constituent unit B more improves affinity for the coloring material and more improves re-dispersibility, dry ejection characteristics, and ejection stability.

Examples of the hydrophilic acrylic acid monomer constituting the constituent unit B include, but are not particularly limited to, acrylic acid monomers having a carboxyl group, such as acrylic acid, methacrylic acid, and the like; and acrylic acid ester monomers such as 2-hydroxyethyl (meth)acrylate and the like. The hydrophilic acrylic acid monomers may be used alone or in combination of two or more. In the present embodiment, “(meth)acrylic acid” includes acrylic acid and methacrylic acid.

In particular, at least any one of acrylic acid, methacrylic acid, and 2-hydroxyethyl acrylate is preferably contained. The use of such a hydrophilic acrylic acid monomer tends to more improve the adsorptivity of the dispersion resin to the coloring material, more improve re-dispersibility after solidification, and more improve the dry ejection characteristics.

In addition, the molecular weight of the hydrophilic acrylic acid monomer constituting the constituent unit B is preferably less than 300 and more preferably 70 to 290.

The content of the constituent unit B relative to the total amount of the dispersion resin is preferably 3 to 25 mol %, more preferably 5 to 20 mol %, and still more preferably 8 to 18 mol %. When the content of the constituent unit B is within the range described above, there is a tendency to more improve the hydrophilicity of the dispersion resin, more improve re-dispersibility after solidification, and more improve the dry ejection characteristics.

### 1.1.3. Constituent Unit C

The constituent unit C is a constituent unit containing a hydrophilic vinyl monomer having a sulfonate group and partially imparts hydrophilicity to the dispersion resin. Although not particularly limited, the constituent unit C is aligned on the side opposite to the surface of the coloring material and thus can contribute to improvement in dispersibility.

Examples of the hydrophilic vinyl monomer having a sulfonate group constituting the constituent unit C include, but are not particularly limited to, compounds represented by formula (1) below. Among these, vinylsulfonic acid is more preferred. The use of such a hydrophilic vinyl monomer tends to more improve the hydrophilicity of the dispersion resin even when a hydrophilic part is decreased, more improve re-dispersibility after solidification, and more improve dry ejection characteristics. These hydrophilic vinyl monomers may be used alone or in combination of two or more.

CH₂=CH—R—SO₃H (1)

In the formula, R represents a linear, branched, or cyclic alkyl group having 1 to 6 carbon atoms.

The sulfonate group in the hydrophilic vinyl monomer may form a salt. Examples of the salt include, but are not particularly limited to, alkali metal salts of potassium and the like; alkaline-earth metal salts of calcium, magnesium, and the like; ammonium salts; and alkylamine salts.

The content of the constituent unit C relative to the total amount of the dispersion resin is preferably 5.0 to 30 mol %, more preferably 7.5 to 25 mol %, and still more preferably 10 to 20 mol %. When the content of the constituent unit C is within the range described above, there is a tendency to more improve the hydrophilicity of the dispersion resin, more improve re-dispersibility after solidification, and more improve the dry ejection characteristics. In particular, having the constituent unit C more improves re-dispersibility after solidification.

### 1.1.4. Weight-Average Molecular Weight and Molecular Weight Distribution

The weight-average molecular weight of the dispersion resin is 10,000 to 100,000, preferably 10,000 to 80,000, and more preferably 10,000 to 60,000. When the weight-average molecular weight of the dispersion resin is within the range described above, there is a tendency to more improve re-dispersibility after solidification and more improve the dry ejection characteristics.

In addition, the molecular weight distribution (Mw/Mn) of the dispersion resin is preferably 1.05 to 2.00, more preferably 1.10 to 1.90, still more preferably 1.20 to 1.85, and particularly preferably 1.30 to 1.80. When the molecular weight distribution of the dispersion resin is within the range described above, there is a tendency to more improve uniformity of molecular sizes, more improve re-dispersibility after solidification, and more improve the dry ejection characteristics. In addition, such a relatively narrow molecular weight distribution can be achieved by living radial polymerization described latter or the like.

The weight-average molecular weight and molecular weight distribution can be measured by a known method using chromatography. More specifically, a method described in examples can be used for measurement.

### 1.1.5. Production Method

The dispersion resin of the present embodiment can be produced by copolymerizing a hydrophobic monomer, a hydrophilic acrylic acid monomer, and a hydrophilic vinyl monomer having a sulfonate group. The polymerization reaction is not particularly limited, but for example, radical polymerization, particularly living radical polymerization, can be used.

### 1.2. Water

The content of water relative to the total amount of the dispersion liquid is preferably 60% to 95% by mass, more preferably 65% to 95% by mass, and still more preferably 75% to 90% by mass.

### 1.3. Coloring Material

The coloring material is not particularly limited, but for example, a disperse dye or a pigment can be used. Among these, the disperse dye is preferred. The use of the disperse dye tends to more improve re-dispersibility after solidification and more improve dry ejection characteristics. These coloring materials may be used alone or in combination of two or more.

Usable examples of the disperse dye include, but are not particularly limited to, known dyes such as C. I. Disperse Yellow, C. I. Disperse Orange, C. I. Disperse Blue, C. I. Disperse Violet, C. I. Disperse Black, and the like.

Examples of an inorganic pigment include, but are not particularly limited to, carbon black (C. I. Pigment Black 7) such as furnace black, lamp black, acetylene black, channel black, and the like, iron oxide, and titanium oxide.

Examples of an organic pigment include, but are not particularly limited to, a quinacridone pigment, a quinacridone-quinone pigment, a dioxazine pigment, a phthalocyanine pigment, an anthrapyrimidine pigment, an anthanthrone pigment, an indanthrone pigment, a flavanthrone pigment, a perylene pigment, a diketopyrrolopyrrole pigment, a perinone pigment, a quinophthalone pigment, an anthraquinone pigment, a thioindigo pigment, a benzimidazolone pigment, an isoindolinone pigment, an azomethine pigment, and an azo pigment.

The content of the coloring material relative to the total amount of the dispersion liquid is preferably 7.5% to 30% by mass, more preferably 7.5% to 25% by mass, and still more preferably 8.5% to 20% by mass.

### 1.4. pH Adjuster

The dispersion liquid may further contain a pH adjuster. Examples of the pH adjuster include, but are not particularly limited to, inorganic acids (for example, sulfuric acid, hydrochloric acid, nitric acid, and the like), inorganic bases (for example, lithium hydroxide, sodium hydroxide, potassium hydroxide, ammonia, and the like), organic bases (for example, triethanolamine, diethanolamine, monoethanolamine, and tripropanolamine), organic acids (for example, adipic acid, citric acid, succinic acid, and the like), and the like. These pH adjusters may be used alone or in combination of two or more.

### 2. Ink Composition for Ink Jet Recording

An ink composition for ink jet recording (also simply referred to as an “ink composition”) according to the present embodiment contains the dispersion liquid, a surfactant, and a water-soluble organic solvent and may, if required, contain other components. The expression “for ink jet recording” represents use by an ink jet method of ejecting ink droplets from nozzles of an ink jet head.

### 2.1. Dispersion Liquid

The dispersion liquid is as described above. The content of the dispersion resin added together with the dispersion liquid to the ink composition relative to the total amount of the ink composition is preferably 0.1% to 3.5% by mass, more preferably 0.3% to 3.0% by mass, and still more preferably 0.5% to 2.5% by mass. When the content of the dispersion resin is within the range described above, there is a tendency to more improve re-dispersibility after solidification and more improve dry ejection characteristics.

The content of the coloring material added together with the dispersion liquid to the ink composition relative to the total amount of the ink composition is preferably 0.5% to 7.0% by mass, more preferably 1.0% to 6.0% by mass, and still more preferably 1.5% to 4.5% by mass. When the content of the coloring material is within the range described above, there is a tendency to more improve re-dispersibility after solidification and more improve dry ejection characteristics.

The content of the dispersion resin relative to 100 parts by mass of the coloring material in the ink composition is preferably 10 to 80 parts by mass, more preferably 15 to 70 parts by mass, and still more preferably 25 to 60 parts by mass. When the content of the dispersion resin is within the range described above, there is a tendency to more improve re-dispersibility after solidification and more improve dry ejection characteristics.

### 2.2. Surfactant

Examples of the surfactant include, but are not particularly limited to, an acetylene glycol-based surfactant, a fluorine-based surfactant, and a silicone-based surfactant.

The acetylene glycol-based surfactant is not particularly limited, but is, for example, preferably one or more selected from 2,4,7,9-tetramethyl-5-decyne-4,7-dol, alkylene oxide adducts of 2,4,7,9-tetramethyl-5-decyne-4,7-diol, 2,4-dimethyl-5-decyne-4-ol, and alkylene oxide adducts of 2,4-dimethyl-5-decyne-4-ol.

Examples of the fluorine-based surfactant include, but are not particularly limited to, perfluoroalkylsulfonate salts, perfluoroalkylcarboxylate salts, perfluoroalkylphosphate esters, perfluoroalkylethylene oxide adducts, perfluoroalkylbetaine, and perfluoroalkylamine oxide compounds.

Examples of the silicone-based surfactant include a polysiloxane-based compound, polyether-modified organosiloxne, and the like.

The content of the surfactant relative to the total amount of the ink composition is preferably 0.1% to 3.0% by mass and more preferably 0.1% to 1.0% by mass.

### 2.3. Water-Soluble Organic Solvent

Examples of the water-soluble organic solvent include, but are not particularly limited to, glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, and the like; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, triethylene glycol monomethyl ether, and the like; nitrogen-containing solvents such as 2-pyrrolidone, N-methyl-2-pyrrolidone, N-ethyl-2-pyrrolidone, and the like; and alcohols such as methanol, ethanol, n-propyl alcohol, iso-propyl alcohol, n-butanol, 2-butanol, tert-butanol, iso-butanol, n-pentanol, 2-pentanol, 3-pentanol, tert-pentanol, and the like. Among these, glycerin, glycols, and glycol monoethers are preferred, and diethylene glycol, propylene glycol, triethylene glycol monomethyl ether, and glycerin are more preferred. The water-soluble organic solvents may be used alone or in combination of two or more.

The content of the water-soluble organic solvent relative to the total amount of the ink composition is preferably 5.0% to 30% by mass and more preferably 10% to 20% by mass. When the content of the water-soluble organic solvent is within the range described above, there is a tendency to more improve re-dispersibility after solidification and more improve dry ejection characteristics.

### 2.4. Water

The content of the water relative to the total amount of the ink composition is preferably 60% to 90% by mass and more preferably 70% to 85% by mass. When the content of the water is within the range described above, there is a tendency to more improve re-dispersibility after solidification and more improve dry ejection characteristics.

### 2.5. pH Adjuster

The ink composition may further contain a pH adjuster. Examples of the pH adjuster include, but are not particularly limited to, those described for the dispersion liquid. The pH adjuster may be derived from the dispersion liquid and mixed in the ink composition or may be separately added when the ink composition is prepared.

The content of the pH adjuster relative to the total amount of the ink composition is preferably 0.1% to 2.0% by mass and more preferably 0.5% to 1.5% by mass.

### 2.6. Other Resin

The ink composition may further contain a resin other than the dispersion resin. Examples of the other resin include, but are not particularly limited to, an anionic resin, a cationic resin, and a nonionic resin. By containing such a resin, the coloring material can be fixed to a recording medium.

Examples of the cationic resin include, but are not particularly limited to, starch derivatives such as cation starch and the like, a cationic urethane resin, a cationic olefin resin, and a cationic allylamine-based resin.

Examples of the anionic resin include cellulose derivatives such as a carboxymethyl cellulose salt, viscose, and the like; and natural resins such as an alginate salt, gum arabic, gum traganth, a ligninsulfonate salt, and the like.

Examples of the nonionic resin include, but are not particularly limited to, an acrylic resin, a styrene-acrylic resin, a urethane-based resin, an ester-based resin, an olefinic resin, and a vinyl acetate-based resin.

The content of the other resin relative to the total amount of the ink composition is preferably 0.1% to 2.0% by mass and more preferably 0.5% to 1.5% by mass.

### EXAMPLES

The present disclosure is described in further detail below by using examples and comparative examples. The present disclosure is not limited to the examples below.

### 1. Synthesis of Copolymer

### 1.1. Production Example 1

In a three-neck flask with a stirring bar and Dimroth condenser set thereto, 82 parts by mass of styrene (manufactured by Tokyo Chemical Industry Co., Ltd.), 10 parts by mass of vinylsulfonic acid (manufactured by Asahi Kasei Corporation), and 8 parts by mass of acrylic acid (manufactured by Tokyo Chemical Industry Co., Ltd.) were placed and dissolved in 30 parts by mass of N,N-dimethylformamide (manufactured by Tokyo Chemical Industry Co., Ltd.). In addition, in another glass bottle, 1 part by mass of azobisisobutyronitrile (manufactured by Fujifilm Wako Pure Chemical Corporation) and 10 parts by mass of N,N-dimethylformamide (manufactured by Tokyo Chemical Industry Co., Ltd.) were placed to prepare an initiator solution.

The solution in the three-neck flask was bubbled with nitrogen for 20 minutes, and then the initiator solution was added dropwise. Then, polymerization reaction was performed for 8 hours by heating to a reflux temperature in a nitrogen atmosphere. After the termination of reaction, the reaction product was added dropwise to water to precipitate a white solid. The precipitated solid was recovered by suction filtration and then vacuum-dried at 50° C. for 10 hours, producing a dispersion resin 1. The weight-average molecular weight of the resultant dispersion resin was 15414.

### 1.2. Production Examples 2 to 8

Dispersion resins 2 to 8 were produced by the same method as in Production Example 1 except that the type and amount of each of the monomers used were changed so as to obtain the dispersion resins shown in Table 1.

### 1.3. Weight-Average Molecular Weight and Molecular Weight Distribution

The weight-average molecular weight and molecular weight distribution (Mw/Mn) of each of the dispersion resins produced as described above were measured by chromatography. The conditions are shown below.

### (Measurement Conditions)

Apparatus name: HLC8320GPC (Tosoh Corporation)
Guard column: Super AW-L
Column: Super AW3000
Colum temperature: 25° C.
Eluent: dimethylacetamide
Flow rate: 0.6 mL/min
Detector: RI

TABLE 1

| | | Monomer mixing ratio (%) | | | | | | | | |
|---|---|---|---|---|---|---|---|---|---|---|
| | | Constituent | | Constituent unit | | | Constituent | | | |
| | | unit A | | B | | | unit C | | | |
| Copolymer | | St | BzA | AA | MAA | HEA | VSA | Mn | Mw | Mw/Mn |
| Production | Dispersion | 82 | | 8 | | | 10 | 11010 | 15414 | 1.4 |
| Example 1 | resin 1 | | | | | | | | | |
| Production | Dispersion | 71 | | | 15 | | 14 | 17049 | 25573 | 1.5 |
| Example 2 | resin 2 | | | | | | | | | |
| Production | Dispersion | 62 | | | | 18 | 20 | 9302 | 10654 | 1.1 |
| Example 3 | resin 3 | | | | | | | | | |
| Production | Dispersion | | 80 | 10 | | | 10 | 28569 | 51425 | 1.8 |
| Example 4 | resin 4 | | | | | | | | | |
| Production | Dispersion | 70 | | 30 | | | | 10001 | 15002 | 1.5 |
| Example 5 | resin 5 | | | | | | | | | |
| Production | Dispersion | 82 | | | | | 18 | 10560 | 13562 | 1.3 |
| Example 6 | resin 6 | | | | | | | | | |
| Production | Dispersion | 82 | | 8 | | | 10 | 5563 | 7763 | 1.4 |
| Example 7 | resin 7 | | | | | | | | | |
| Production | Dispersion | 50 | | 30 | | | 20 | 12647 | 17582 | 1.4 |
| Example 8 | resin 8 | | | | | | | | | |

St: Styrene
BzA: Benzyl acrylate
BA: Butyl acrylate
AA: Acrylic acid
MAA: Methacrylic acid
HEA: 2-Hydroxyethyl acrylate
VSH: Vinylsulfonic acid

### 2. Preparation of Varnish Solution

In a 1-L eggplant-shaped flask with a stirring bar and Dimroth condenser set thereto, 15 parts by mass of a copolymer and 70 parts by mass of pure water were added, heated to 80° C., and then stirred. Then, triethanolamine was added until the pH became 8.0, and pure water was further added up to a total of 100 parts by mass. Then, the resultant mixture was cooled to 25° C., preparing a varnish solution containing 15% by mass of the copolymer.

### 3. Preparation of Dispersion Liquid

Added were 50 parts by mass of the varnish solution, 15 parts by mass of DISPERSE YELLOW 82, and 35 parts by mass of pure water. The resultant mixture was sufficiently mixed by dispersion with a beads mill containing zirconia beads having a diameter of 0.3 mm, preparing a dispersion liquid containing 7.5% by mass of the copolymer and 15% by mass of the coloring material.

### 4. Preparation of Ink Composition

The dispersion liquid was mixed with other components so as to obtain the composition shown in Table 2, preparing each of the ink compositions.

### 5. Evaluation

### 5.1. Re-Dispersibility

The ink composition prepared as described above was dropped on a slide glass and then solidified by drying for 16 hours in a dryer of 40° C. Then, the slide glass was dipped in a sample bottle containing ink water, and the re-dispersion behavior of a solid was confirmed by visual observation. This operation was performed with attention so that the ink water was not stirred or the like. The ink water represents not containing the coloring material and the dispersion resin shown in Table 2. The evaluation criteria of re-dispersibility are shown below.

### Evaluation Criteria

A: The solid disappeared, and re-dispersion was observed.
B: The solid partially remained, but re-dispersion was observed.
C: The solid remained, and re-dispersion was not observed.

### 5.2. Ejection Stability

An ink jet-system printer EM-930C (trade name, manufactured by Seiko Epson Corporation) was filled with an ink composition for ink jet recording, and printing was continuously performed for 2 hours. A nozzle check pattern of nozzles used for printing was printed before and after printing to confirm the nozzles causing a deteriorating deviation of landing positions. In this case, the number of the nozzles was 180. The evaluation criteria are as follows. The evaluation result “A” or “B” can be determined as “good”.

### Evaluation Criteria

A: The number of nozzles with a deteriorating deviation of the landing positions was 1% or less.
B: The number of nozzles with a deteriorating deviation of the landing positions was over 1% and 5% or less.
C: The number of nozzles with a deteriorating deviation of the landing positions was over 5%.

### 5.3. Dry Ejection Characteristics

An ink jet-system printer EM-930C (trade name, manufactured by Seiko Epson Corporation) was filled with an ink composition for ink jet recording, and an ejection head was removed from a suctioning cap and allowed to stand for 1 day. After allowing to stand, cleaning was performed once, and continuous printing was performed on 20 pages under ejection from all nozzles to determine the number of nozzles causing printing omission/bending based on the following criteria. The evaluation result “A” or “B” can be determined as “good”.

### Evaluation Criteria

A: No nozzles causing omission/bending
B: 1 to 5 nozzles causing omission/bending
C: 6 or more nozzles causing omission/bending

TABLE 2

| | | Example 1 | | | | Comparative Example 1 | | | |
|---|---|---|---|---|---|---|---|---|---|
| | | 1 | 2 | 3 | 4 | 1 | 2 | 3 | 4 |
| Coloring material | | 3.0 | 3.0 | 3.0 | 3.0 | 3.0 | 3.0 | 3.0 | 3.0 |
| Dispersion resin 1 | | 1.5 | | | | | | | |
| Dispersion resin 2 | | | 1.5 | | | | | | |
| Dispersion resin 3 | | | | 1.5 | | | | | |
| Dispersion resin 4 | | | | | 1.5 | | | | |
| Dispersion resin 5 | | | | | | 1.5 | | | |
| Dispersion resin 6 | | | | | | | 1.5 | | |
| Dispersion resin 7 | | | | | | | | 1.5 | |
| Dispersion resin 8 | | | | | | | | | 1.5 |
| pH | Triethanolamine | 0.5 | 0.5 | 0.5 | 0.5 | 0.5 | 0.5 | 0.5 | 0.5 |
| adjuster | | | | | | | | | |
| Surfactant | BYK348 | 0.5 | 0.5 | 0.5 | 0.1 | 0.1 | 0.1 | 0.1 | 0.1 |
| | Olfine E1010 | 0.5 | 0.5 | 0.5 | 0.5 | 0.5 | 0.5 | 0.5 | 0.5 |
| Water- | Propylene glycol | 5.0 | 5.0 | 5.0 | 5.0 | 5.0 | 5.0 | 5.0 | 5.0 |
| soluble | Triethylene | 5.0 | 5.0 | 5.0 | 5.0 | 5.0 | 5.0 | 5.0 | 5.0 |
| organic | glycol monobutyl | | | | | | | | |
| solvent | ether | | | | | | | | |
| | Glycerin | 7.0 | 7.0 | 7.0 | 7.0 | 7.0 | 7.0 | 7.0 | 7.0 |
| | Diethylene | 5.0 | 5.0 | 5.0 | 5.0 | 5.0 | 5.0 | 5.0 | 5.0 |
| | glycol | | | | | | | | |
| Water | | Balance | Balance | Balance | Balance | Balance | Balance | Balance | Balance |
| Total | | 100 | 100 | 100 | 100 | 100 | 100 | 100 | 100 |
| Evaluation | Re-dispersibility | A | A | A | A | C | C | B | C |
| | Ejection stability | A | A | A | B | C | B | B | B |
| | Dry ejection | A | B | A | B | C | C | C | C |
| | characteristics | | | | | | | | |

BYK-348: Silicone-based surfactant manufactured by BYK Chemie Co., Ltd.
Olfine E1010: Acetylene glycol-based surfactant, manufactured by Nisshin Chemical Industry Co., Ltd.

As described above, it is found that the ink compositions of the examples using the dispersion liquid of the present disclosure have excellent re-dispersibility, more improved dry ejection characteristics, and excellent ejection stability as compared with the comparative examples.

What is claimed is:

1. A dispersion liquid comprising:
water;
a coloring material; and
a dispersion resin that disperses the coloring material,
wherein the dispersion resin has a constituent unit A containing a hydrophobic monomer, a constituent unit B containing a hydrophilic acrylic acid monomer, and a constituent unit C containing a hydrophilic vinyl monomer having a sulfonate group;
the weight-average molecular weight of the dispersion resin is 10,000 to 100,000; and
the content of the constituent unit A is 60 mol % or more relative to the total amount of the dispersion resin.

2. The dispersion liquid according to claim 1, wherein the molecular weight distribution (Mw/Mn) of the dispersion resin is 1.05 to 2.00.

3. The dispersion liquid according to claim 1, wherein the content of the constituent unit A relative to the total amount of the dispersion resin is 62 to 82 mol %.

4. The dispersion liquid according to claim 1, wherein the content of the constituent unit B relative to the total amount of the dispersion resin is 8 to 18 mol %.

5. The dispersion liquid according to claim 1, wherein the content of the constituent unit C relative to the total amount of the dispersion resin is 10 to 20 mol %.

6. The dispersion liquid according to claim 1, wherein the hydrophobic monomer contains at least either a vinyl monomer having an aromatic group or an acrylate ester monomer having a hydrocarbon group.

7. The dispersion liquid according to claim 1, wherein the hydrophilic acrylic acid monomer contains at least either of (meth)acrylic acid and 2-hydroxyethyl acrylate.

8. The dispersion liquid according to claim 1, wherein the hydrophilic vinyl monomer contains vinylsulfonic acid.

9. The dispersion liquid according to claim 1, wherein the coloring material is a disperse dye.

10. The dispersion liquid according to claim 1, wherein the content of the coloring material relative to the total amount of the dispersion liquid is 7.5% to 30% by mass.

11. The dispersion liquid according to claim 1, wherein the content of the dispersion resin relative to the total amount of the dispersion liquid is 2.5% to 12.5% by mass.

12. An ink composition for ink jet recording comprising:
the dispersion liquid according to claim 1;
a surfactant; and
a water-soluble organic solvent.

13. A dispersion resin comprising:
a constituent unit A containing a hydrophobic monomer;
a constituent unit B containing a hydrophilic acrylic acid monomer; and
a constituent unit C containing a hydrophilic vinyl monomer having a sulfonate group,
wherein the weight-average molecular weight of the dispersion resin is 10,000 to 100,000; and
the content of the constituent unit A is 60 mol % or more relative to the total amount of the dispersion resin.
